(19) United States
(12) Patent Application Publication
(10) Pub. No.: US 2009/0293051 A1
(43) Pub. Date: Nov. 26, 2009

(54) MONITORING AND DYNAMIC TUNING OF TARGET SYSTEM PERFORMANCE

(75) Inventor: Andrew Krywaniuk, Vancouver (CA)

Correspondence Address: MICHAEL A DESANCTIS;HAMILTON DESANCTIS & CHA LLP, FINANCIAL PLAZA AT UNION SQUARE, 225 UNION BOULEVARD, SUITE 305, LAKEWOOD, CO, 80228, US

(73) Assignee: FORTINET, INC., A Delaware Corporation

(21) Appl. No.: 12/125,910

(22) Filed: May 22, 2008

(51) Int. Cl. G06F 9/44; G06F 15/177

(52) U.S. Cl. 717/173; 709/221

(57) ABSTRACT

Methods and systems for remotely monitoring and tuning the performance of one or more target systems are provided. According to one embodiment, a separate tuning server receives data, such as profiling data, that has been collected regarding a target system. Then, if based on the data it is determined that performance attributes of the target system can be improved, the performance of the target system is dynamically tuned. Depending upon the circumstances, the target system may be caused to replace an application component of a program being executed by the target system with a new application component, which may be contained within an image chosen from a set of pre-built images or built and compiled by the tuning server specifically for the target system. In some cases, the dynamic tuning of the performance of the target system may involve making a change to a configuration file on the target system.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2008, Fortinet, Inc.

### BACKGROUND

1. Field

Embodiments of the present invention generally relate to performance tuning and optimization. In particular, embodiments of the present invention relate to dynamic monitoring and tuning of embedded systems based on profile points provided to a remote, managed and/or centralized analysis/tuning server.

2. Description of the Related Art

Many software and hardware systems are over-engineered. That is, software and hardware systems are typically more sophisticated than they need to be as a result of including functionality and features designed to address the needs of an assumed worst case environment or the perceived needs of an identified group of end users. For example, a tiered family of products may be designed for use by work groups of a certain size, e.g., one to five, five to twenty, twenty to one hundred and one hundred or more. However, when a customer having five users purchases the product designed for a group of five to twenty, there may exist features and functionality, and configuration parameters that are not optimized for this particular customer's usage. For example, various features that would be expected to be employed by a larger user group may not be needed by a smaller user group.

In the context of a networking product, a one hundred feature box may be purchased by a customer that only requires a subset of the functionality. The overhead of code, hardware and memory (e.g., random access memory (RAM)) dedicated to those of the features not being used may impact the performance of that are being employed.

Existing system performance and optimization solutions require end users or administrators to enable or disable features via compile time options and/or configuration files. Many open source software packages have compile time options to enable individual features or tune parameters; however, these can be difficult to use and can be error prone. Meanwhile, recompilation requires access to the source code, which makes such compile time mechanisms undesirable to many commercial software providers. Some software packages have install-time dialogs to let the user customize which optional packages to install. However, this puts the burden of streamlining the installation on the end user, who may not know in advance which specific modules will be needed. Other software packages have configuration files from which the user can enable or disable different features or tune parameters; however the actual code doesn't change, thus there remains overhead in wasted code, suboptimal code paths and additional time is required to read and interpret the parameters.

Furthermore, in the arena of embedded computing, hardware costs are very relevant to profit margin. Many devices don't have a lot of spare memory and/or processor power to devote to self-profiling. Nor do they have the resources necessary for on the fly recompilation of their source code.

Thus, there is a need in the art for improved performance tuning solutions.

### SUMMARY

Methods and systems are described for externally monitoring and tuning the performance of one or more target systems. According to one embodiment, a separate tuning server receives data that has been collected regarding a target system. Then, if based on the data it is determined that performance attributes of the target system can be improved, the performance of the target system is dynamically tuned.

In the aforementioned embodiment, the target system may be caused to replace an application component of a program being executed by the target system with a new application component.

In various of the aforementioned embodiments, the new application component may be contained within an image chosen from a set of pre-built images.

In the context of various of the aforementioned embodiments, the new application component may be built and compiled by the separate tuning server specifically for the target system based on the data.

In some instances of the aforementioned embodiments, the dynamic tuning of the performance of the target system may involve making a change to a configuration file and/or a script file on the target system.

In various of the aforementioned embodiments, the method may also involve applying a hot patch to an image on the target system.

In the context of various of the aforementioned embodiments, the data collected and received from the target system may represent profiling data.

In the aforementioned embodiment, the profiling data may include information indicative of active or inactive code paths of the existing program during a profiling period and the method may additionally involve the separate tuning server (i) causing a first module or first section of code within the existing program to be restructured to provide more efficient code paths for more frequently encountered inputs or (ii) causing a second module or second section of code to be removed from the existing program based on the profiling data.

In the context of various of the aforementioned embodiments, the data collected and received from the target system may represent metrics relating to memory utilization by the target system, central processor unit utilization by the target system, latency in processing a request by the target system, time spent in input/output operations by the target system, time spent swapping to a mass storage medium by the target system, occurrence of certain faults within the target system, load at various times of day on the target system, distribution of protocols in traffic being processed by the target system, and/or frequency of security incidents observed by the target system.

In the aforementioned embodiment, the separate tuning server may cause a value of a system parameter of the target system to be changed responsive to analysis of the metrics.

In the context of various of the aforementioned embodiments, the data collected and received from the target system may include information indicative of attacks attempted against the target system and wherein the method further comprises the separate tuning server causing code to mitigate the attacks to be uploaded to the target system.

In some instances of the aforementioned embodiments, the new application component may include randomly generated changes that do not provide any tuning advantage, but which provide resistance to known attacks via code polymorphism.

In the context of various of the aforementioned embodiments, the new application component may be recompiled after enabling or disabling one or more conditional compilation options within source code of the program.

In the aforementioned embodiment, the new application component may enable or disable symmetric multiprocessing, hyper-threading or may configure other processor-specific options on the target system.

In various of the aforementioned embodiments, the dynamic tuning of the performance of the target system may involve upgrading firmware of a peripheral associated with the target system.

In the context of various of the aforementioned embodiments, the dynamic tuning of the performance of the target system involves supplying a new bit image to a field-programmable gate array (FPGA) associated with the target system.

In the context of various of the aforementioned embodiments, the data collected and received from the target system includes configuration information indicative of whether certain services are enabled or disabled within the target system.

In the aforementioned embodiment, the separate tuning server may cause files or code associated with one or more disabled services to be removed from the target system.

In the context of various of the aforementioned embodiments, the separate tuning server may be customer-premises equipment (CPE) located geographically proximate to the target system.

In the context of various of the aforementioned embodiments, the separate turning server may be service provider equipment (SPE) located geographically remote from the target system.

Other embodiments of the present invention provide a computer system, such as a tuning server, including a storage device having stored therein a software program configured to determine a need for performance tuning in relation to a separate target system and a processor coupled to the storage device and configured to execute the software program to analyze profiling data received from the separate target system. The profiling data provides information regarding active or inactive code paths of a program executed by the separate target system during a profiling period. Based on the profiling data, if it is determined that one or more performance attributes of the separate target system can be improved, then the software program causes the performance of the separate target system to be dynamically tuned.

In the aforementioned embodiment, the software program may be further configured to cause the separate target system to replace an application component of a program being executed by the separate target system with a new application component.

In various instances of the aforementioned embodiments, the software program may (i) cause a first module or first section of code within an existing program running on the separate target system to be restructured to provide more efficient code paths for more frequently encountered inputs or (ii) cause a second module or second section of code to be removed from the existing program based on the profiling data.

In the context of various of the aforementioned embodiments, the software program may additionally receive from the separate target system metrics relating to memory utilization by the remove target system, central processor unit utilization by the separate target system, latency in processing a request by the separate target system, time spent in input/output operations by the separate target system, time spent swapping to a mass storage medium by the separate target system, occurrence of certain faults within the separate target system, load at various times of day on the separate target system, distribution of protocols in traffic being processed by the separate target system and/or frequency of security incidents observed by the separate target system.

In some instances of the aforementioned embodiments, the software program may cause a value of a system parameter of the separate target system to be changed responsive to analysis of the metrics.

In the context of various of the aforementioned embodiments, the software program may additionally receive from the separate target system information indicative of attacks attempted against the separate target system and wherein the software program further causes code to mitigate the attacks to be uploaded to the separate target system.

In the context of various of the aforementioned embodiments, the dynamic tuning of the performance of the separate target system may involve upgrading firmware of a peripheral associated with the separate target system.

In the context of various of the aforementioned embodiments, the dynamic tuning of the performance of the separate target system may involve supplying a new bit image to a field-programmable gate array (FPGA) associated with the separate target system.

In various instances of the aforementioned embodiments, the software program may additionally receive from the separate target system configuration information indicative of whether certain services are enabled or disabled within the separate target system and the software program may further configured to cause files or code associated with one or more disabled services to be removed from the separate target system.

In the context of various of the aforementioned embodiments, the computer system may be customer-premises equipment (CPE) located geographically proximate to the separate target system.

In the context of various of the aforementioned embodiments, the computer system may be service provider equipment (SPE) located geographically remote from the separate target system.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram conceptually illustrating a simplified network architecture in which embodiments of the present invention may be employed.

FIG. 2 is a block diagram conceptually illustrating various functional units of a tuning server and a target system and interaction between the tuning server and the target system in accordance with one embodiment of the present invention.

FIG. 3 is an example of a computer system with which embodiments of the present invention may be utilized.

FIG. 4 is a high-level flow diagram illustrating performance tuning processing in accordance with an embodiment of the present invention.

FIG. 5 is a flow diagram illustrating target system data collection processing in accordance with an embodiment of the present invention.

FIG. 6 is a flow diagram illustrating monitoring processing in accordance with an embodiment of the present invention.

FIG. 7 is a flow diagram illustrating analysis processing in accordance with an embodiment of the present invention.

FIG. 8 is a flow diagram illustrating target system reconfiguration processing in accordance with an embodiment of the present invention.

### DETAILED DESCRIPTION

Methods and systems are described for monitoring and tuning system performance. Centralizing the profiling and recompilation/reconfiguration of a target system onto a separate tuning server is thought to make better use of the resources of both the target system (e.g., an embedded device) and the tuning server. The target device can be optimized for its central purpose, and the tuning server can be optimized for tuning multiple target devices.

In the course of data collection, one or more of a variety of profiling techniques may be used. In some instances these techniques may incur very low performance overhead on the target system. According to one embodiment, a target system, the performance of which is to be tuned, runs code containing profile points. Each time a specific code path is followed, a global counter may be incremented. Thus, when the target system is running, a table of executed code paths, for example, may be produced. A central analysis/tuning server may then be provided with data associated with the target system including one or more of profiling data, metrics, configuration information and the like. The central analysis/tuning server may then analyze the collected target system data to choose which actions to take with respect to the target system. For example, one or more individual components of the target system may be upgraded.

In some deployment scenarios, the analysis/tuning server may be customer premises equipment (CPE). In other cases, a service provider or software vendor manages one or more analysis/tuning servers and uses them for the benefit of multiple customers as part of a network tuning service. In yet other situations, an analysis/tuning server could be sold to a customer, but it may still report back to a service provider with aggregated tuning data and/or anomalies.

In some cases, central analysis/tuning server(s) may recompile a binary application after enabling/disabling some conditional compilation options. In some cases, the new code may enable/disable symmetric multiprocessing (SMP) or hyper-threading on the target system or configure other processor-specific options. In some cases, the new code may reconfigure and/or upgrade peripheral hardware or firmware on the target system. In some cases, the new code may include a custom bit image for a field-programmable gate array (FPGA) or other programmable logic chip associated with the target system.

Reconfiguration of the target system by the centralized analysis/tuning server(s) may also include changing the value of one or more system parameters, such as altering the size of a cache or the sizes of other pre-allocated memory pools. The optimization may also remove modules or sections of code that (i) have not been used for some time, (ii) are not currently being used and (iii) are not likely to be used in the near future by the target system.

In some cases, the update may also include bug fixes or workarounds for known security issues. Such updates may restore files that were removed by a previous optimization. In some embodiments, the update may include some randomly generated changes that do not provide any tuning advantage, but which provide resistance to known attacks via code polymorphism. For example, randomized code changes may be introduced that do not affect the functionality of a program, but which change the program's address space to subvert standard buffer overrun attacks. In some embodiments, code to mitigate observed attack/virus signatures may be downloaded from the central analysis server(s) to the target system.

For purposes of simplicity, various embodiments of the present invention are described in the context of a managed service for performance tuning, which is provided by one or more centralized analysis/tuning servers. It is to be noted, however, that the analysis/tuning servers may also provide or otherwise be part of a larger managed service offering that provides other services to subscribers, such as one or more of managed application services, managed backup/recovery services, managed content services, managed desktop services, managed email services, managed IT services, managed network services, managed security services, managed storage services, managed telephony services and the like.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

### Terminology

Brief definitions of terms used throughout this application are given below.

The phrase “application component” generally refers to one or more of the files that is used to run a software program on a target system. This may comprise, for example, executable files, Dynamic Link Library (DLL) files or other libraries, Java byte code, script files, and data files that are used in the execution of the software.

The terms “connected” or “coupled” and related terms are used in an operational sense and are not necessarily limited to a direct connection or coupling.

The term “client” generally refers to an application, program, process or device in a client/server relationship that requests information or services from another program, process or device (a server) on a network. Importantly, the terms “client” and “server” are relative since an application may be a client to one application but a server to another. The term “client” also encompasses software that makes the connection between a requesting application, program, process or device to a server possible, such as an email client.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The phrase “profiling data” generally refers to statistics, counters, stack traces, timing information, or sample input /output data from a target system. In one embodiment, profiling data may be transferred to a tuning server that analyzes the profiling results and performs appropriate actions to tune the performance of the target server.

The term “responsive” includes completely or partially responsive.

The term “server” generally refers to an application, program, process or device in a client/server relationship that responds to requests for information or services by another program, process or device (a server) on a network. The term “server” also encompasses software that makes the act of serving information or providing services possible. The term “server” also encompasses software that makes the act of serving information or providing services possible.

The phrase “target system” generally refers a computing device that is being tuned/optimized. The tuning/optimization may be responsive to an analysis step performed by a remote tuning server.

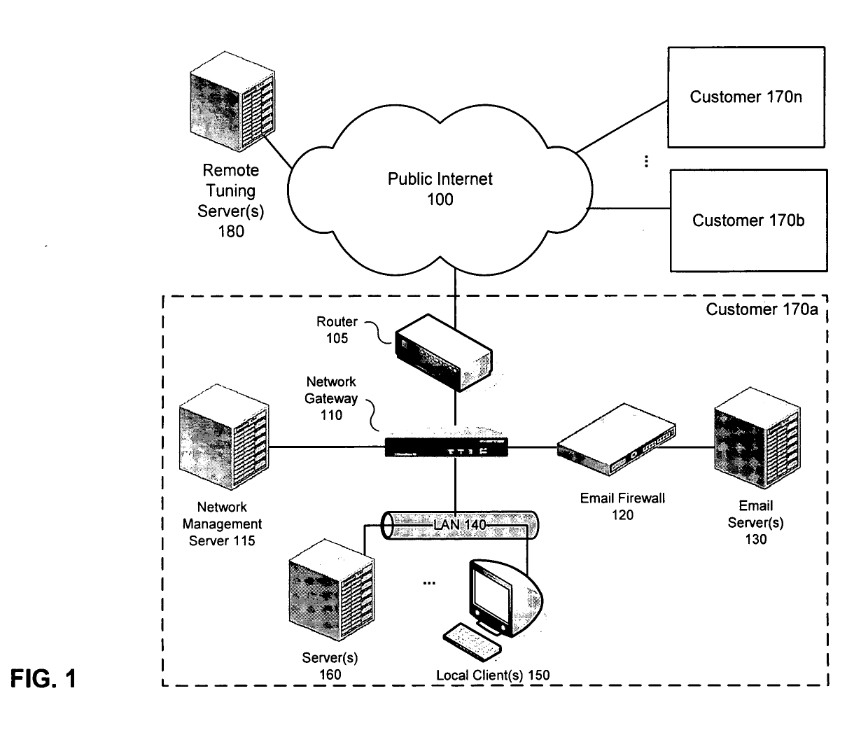

FIG. 1 is a block diagram conceptually illustrating a simplified network architecture in which embodiments of the present invention may be employed. In the present example, one or more remote tuning servers 180 are coupled in communication with multiple customer sites 170a-n via a network, such as the public Internet 100.

According to one embodiment of the present invention, remote tuning server(s) 180 are part of a managed service for performance tuning provided by a service provider (SP) network (not shown). In such an embodiment, the remote tuning server(s) 180 may be configured to provide remote analysis of profiling and/or other data received from target systems associated with one or more of customer sites 170a-n.

As described further below, a variety of profiling techniques may be used by target systems within the customer sites 170a-n depending upon the particular implementation. According to one embodiment, one or more target systems within the customer sites 170a-n run code containing profile points. When specific code paths are followed, corresponding global counters may be incremented. In this manner, tables or traces of executed code paths may be produced. The remote tuning server(s) 180 may then be provided with the profiling data and/or other data associated with the target systems, including performance metrics, configuration information and the like, which is analyzed by the remote tuning server(s) 180 to determine appropriate actions to take with respect to the target systems. For example, one or more individual components of the target system may be upgraded.

In alternative embodiments, a subset or all of the analysis and tuning functionality may be performed by customer premises equipment (CPE) (not shown) owned by the customer and located locally within the customer's premises, such as within customer site 170a-n, for example.

As a simplified illustration of an exemplary customer site, customer site 170a is shown including a router 105, a network gateway 110, an email firewall 120, one or more email servers 130, a network management server 115, a local area network 140, one or more application/file servers 160 and one or more local clients 150. The network devices shown within customer site 170a are examples of target systems, e.g., various equipment/devices that might be monitored and/or tuned by remote tuning server(s) 180. In one embodiment, the remote tuning server(s) 180 collect input regarding the configuration, operation, or profiling data of one or more target systems via another intermediate device, such as network management server 115 or a log aggregation server (not shown). In other embodiments, the remote tuning server(s) 180 collect profiling input directly from the target systems.

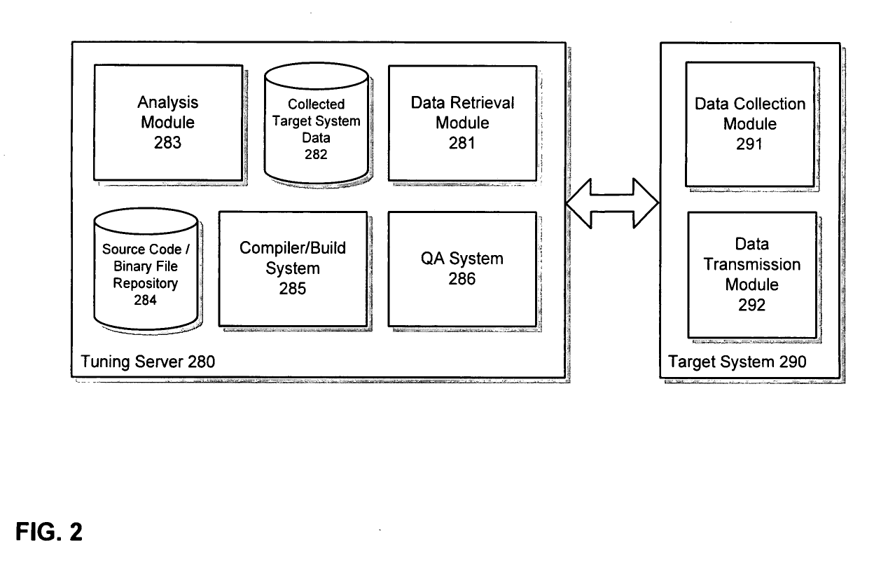

FIG. 2 is a block diagram conceptually illustrating various functional units of a tuning server 280 and a target system 290 and interaction between the tuning server 280 and the target system 290 in accordance with one embodiment of the present invention. In the present example, the target system 290 includes a data collection module 291 and a data transmission module 292.

According to various embodiments, the data collection module 291 receives, stores and potentially packages data regarding the target system 290 for use by the tuning server 280. As indicated above, in one embodiment, the target system 290, the performance of which is to be monitored and tuned by the tuning server 280, runs code containing code instrumentation, such as profile points. When code paths containing profile points are followed, corresponding performance counters may be incremented to create tracking information indicative of active/inactive code paths within the code.

In alternative embodiments, an event based profiler (not shown) or a statistical profiler (not shown) may use hardware interrupts and/or operating system hooks to trap events of interest or probe the program counter of the target system 290 at predetermined times or intervals. Examples of existing statistical profilers include GNU's gprof, Oprofile and SGI's Pixie. Other types of profiling may involve analysis of run time memory usage, interrupt latency, or other such metrics. Depending upon the particular implementation, various other program analysis tools, such as valgrind or libleaky, may be used to capture information about program behavior on the target system 290.

In various embodiments, other information and/or metrics may be collected in addition to or instead of profiling data. For example, the data collection module 291 may gather configuration information in the form of selected system parameters, configuration files, operating system settings and/or settings for applications or other target system processes. Additionally or alternatively, as described further below, the data collection module 291 may monitor and log selected system performance metrics and attack/virus signatures.

In some cases, the data collection module 291 may aggregate profile data or tuning data from multiple target systems in order to create an overall usage summary for one network or customer. With the permission of the customer, this aggregated data could be transmitted back to the hardware/software manufacturers for use in creating future hardware/software revisions, for example.

In one embodiment, the data transmission module 292 interacts with the tuning server 280 to provide the tuning server 280 with the collected target system data. In one embodiment, the tuning server 280 is provided with an account on the target system 290, and the tuning server 280 logs into the target system 290 to retrieve the collected target system data via the data transmission module 292. In other embodiments, the data transmission module 292 communicates the collected target system data to the tuning server 280 via a dedicated protocol. For example, the simple network management protocol (SNMP) could be extended to support the communication of the collected target system data via polling. Alternately, the data transmission module 292 and the tuning server 280 may use a custom transmission control protocol (TCP) to transmit the collected target system data from the target system 290 to the tuning server 280. Furthermore, the collected target system data could be encapsulated in a file and sent by e-mail. It is to be understood that there exist many possible transmission mechanisms between the target system 290 and the tuning server 280; and any of a variety of these could be used in a typical deployment.

In the present example, the tuning server 280 includes a data retrieval module 281, collected target system data 282, an analysis module 283, a source code/binary file repository 284, a compiler/build system 285 and a quality assurance (QA) system 286.

The data retrieval module 281 actively or passively collects target system data that is to be processed. As described further below, depending upon the particular implementation, the data retrieval module 281 may pull profiling and/or other data by proactively interrogating the target system 290 or the target system 290 may push the data to the data retrieval module 281. Regardless of the method of obtaining the target system data, the data retrieval module 281 may create a local data store of collected target system data 282.

According to various embodiments of the present invention, the analysis module 283 performs various evaluation techniques on the collected target system data 282 to identify potential performance tuning/optimization opportunities. For example, based on profiling data collected from the target system 290, the analysis module 283 may ascertain bottlenecks within frequently executed code paths or the analysis module 283 may identify potential optimization paths in view of observed recurring input data patterns.

According to the present example, the source code/binary file repository 284 may have stored therein source code for one or more programs installed on the target system 290. The source code/binary file repository 284 may also include binary patch files and/or pre-built images for various common usage scenarios.

To the extent the performance tuning need identified by the analysis module 283, requires generation of a new image, the compiler/build system 285 may identify and retrieve appropriate source code from the source code/binary file repository 284 and compile the new image. In one embodiment, when a new image is built, it may be tested by QA system 286 before the new image is deployed to the target system 290.

In some embodiments, an upgraded image can be selected from a set of pre-built images. The pre-built images may be built in advance to address common performance issues, thereby allowing the target system 290 to be tuned without the need for compilation by the tuning server 280. Alternatively, a modified image may be created without full recompilation by applying a binary patch. In some cases, hot patches may be applied on the fly to the running copy of the image on the target system 290 without even having to restart the application being updated.

Notably, in some cases, the tuning server 280 may not compile a new image or even upgrade an image on the target system 290. Instead, only a change to a configuration file, a set of one or more system parameters or a set of one or more operating system settings may be performed by the tuning server 280. Additionally, in the case where an update file is decompressed into multiple target files, any one of these files could be upgraded separately. In some cases, tuning may involve the overwriting of one or more files, the application of a patch file and/or upgrading of a package (e.g., several files in an archive with directives regarding how to process them).

While in the environment of the present example, the data retrieval module 281, the collected target system data 282, the analysis module 283, the source code/binary file repository 284, the compiler/build system 285 and the quality assurance (QA) system 286 have been described as residing within or as part of a single tuning server, in alternative embodiments one or more of these functional units may be implemented within a separate server. For example one server may be dedicated to performing analysis and another may be dedicated to performing tuning. In some cases, analysis may be performed by one server and recompilation may be performed by another server.

In the present example, the data collection module 291 and data transmission module 292 have been described as residing within or as part of the target system 290, in alternative embodiments one or both of these functional units may be implemented within a separate device. For example, in some embodiments, the tuning server 280 may collect input regarding the configuration, operation or profiling data regarding one or more target systems via an intermediate device, such as network management server 115 or a log aggregation server (not shown). In such embodiments, one or both of the data collection module 291 and the data transmission module 292 may reside within an intermediate device, which is logically interposed between the tuning server 280 and one or more target systems. In some cases, the tuning server may cause a software agent to be installed on the target system (e.g. to act as a component of the data collection and/or data transmission module).

In one embodiment, the functionality of one or more of the above-referenced functional units may be merged in various combinations. For example, source code/binary file repository 284, compiler/build system 285 and QA system 286 and/or the data retrieval module 281, the collected target system data 282 and the analysis module 283 may be combined. Moreover, the various functional units can be communicatively coupled using any suitable communication method (e.g., message passing, parameter passing, and/or signals through one or more communication paths, etc.). Additionally, the functional units can be physically connected according to any suitable interconnection architecture (e.g., fully connected, hypercube, etc.).

According to embodiments of the invention, the functional units can be any suitable type of logic (e.g., digital logic, software code and the like) for executing the operations described herein. Any of the functional units used in conjunction with embodiments of the invention can include machine-readable media including instructions for performing operations described herein. Machine-readable media include any mechanism that provides (i.e., stores and/or transmits) information in a form readable by a machine (e.g., a computer). For example, a machine-readable medium includes read only memory (ROM), random access memory (RAM), magnetic disk storage media, optical storage media or flash memory devices.

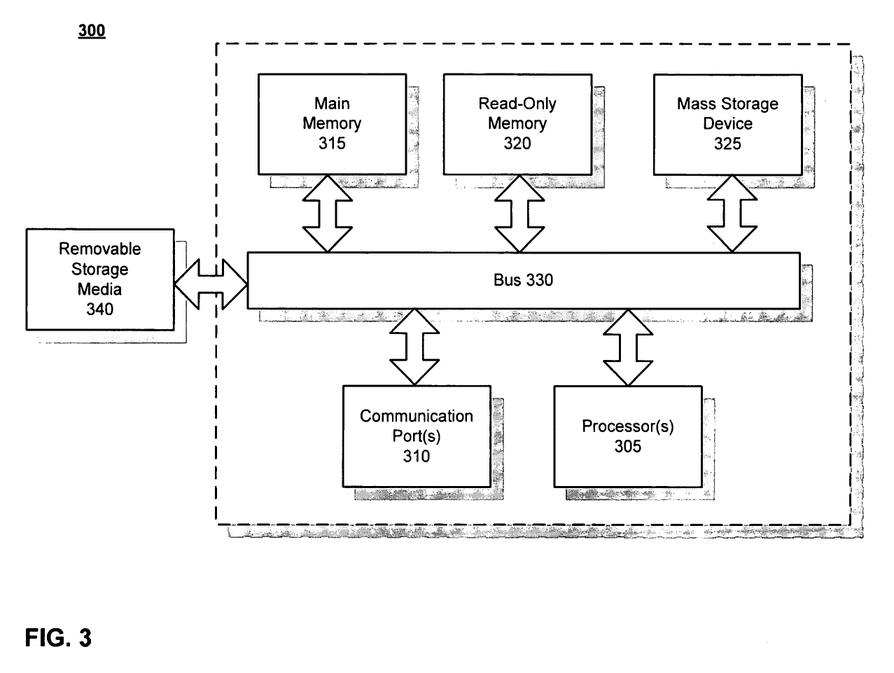

FIG. 3 is an example of a computer system with which embodiments of the present invention may be utilized. The computer system 700 may represent or form a part of a tuning server, an analysis server, a network management server, a log aggregation server, a target system and/or other devices implementing some subset of functionality of a tuning server 280 or a target system 290 or the functional units depicted in FIG. 2. According to FIG. 3, the computer system 300 includes one or more processors 305, one or more communication ports 310, main memory 315, read only memory 320, mass storage 325, a bus 330, and removable storage media 340.

The processor(s) 305 may be Intel® Itanium® or Itanium 2® processor(s), AMD® Opteron® or Athlon MP® processor(s) or other processors known in the art.

Communication port(s) 310 represent physical and/or logical ports. For example communication port(s) may be any of an RS-232 port for use with a modem based dialup connection, a 10/100 Ethernet port, or a Gigabit port using copper or fiber. Communication port(s) 310 may be chosen depending on a network such a Local Area Network (LAN), Wide Area Network (WAN), or any network to which the computer system 300 connects.

Communication port(s) 310 may also be the name of the end of a logical connection (e.g., a TCP port or a Universal Datagram Protocol (UDP) port). For example communication ports may be one of the Well Known Ports, such as TCP port 161 (used for SNMP), TCP port 25 (used for Simple Mail Transfer Protocol (SMTP)) and TCP port 80 (used for HTTP service), assigned by the Internet Assigned Numbers Authority (IANA) for specific uses.

Main memory 315 may be Random Access Memory (RAM), or any other dynamic storage device(s) commonly known in the art.

Read only memory 320 may be any static storage device(s) such as Programmable Read Only Memory (PROM) chips for storing static information such as instructions for processors 305.

Mass storage 325 may be used to store information and instructions. For example, hard disks such as the Adaptec® family of SCSI drives, an optical disc, an array of disks such as RAID, such as the Adaptec family of RAID drives, or any other mass storage devices may be used.

Bus 330 communicatively couples processor(s) 305 with the other memory, storage and communication blocks. Bus 330 may be a PCI /PCI-X or SCSI based system bus depending on the storage devices used.

Optional removable storage media 340 may be any kind of external hard-drives, floppy drives, IOMEGA® Zip Drives, Compact Disc-Read Only Memory (CD-ROM), Compact Disc-Re-Writable (CD-RW), Digital Video Disk (DVD)-Read Only Memory (DVD-ROM), Re-Writable DVD and the like.

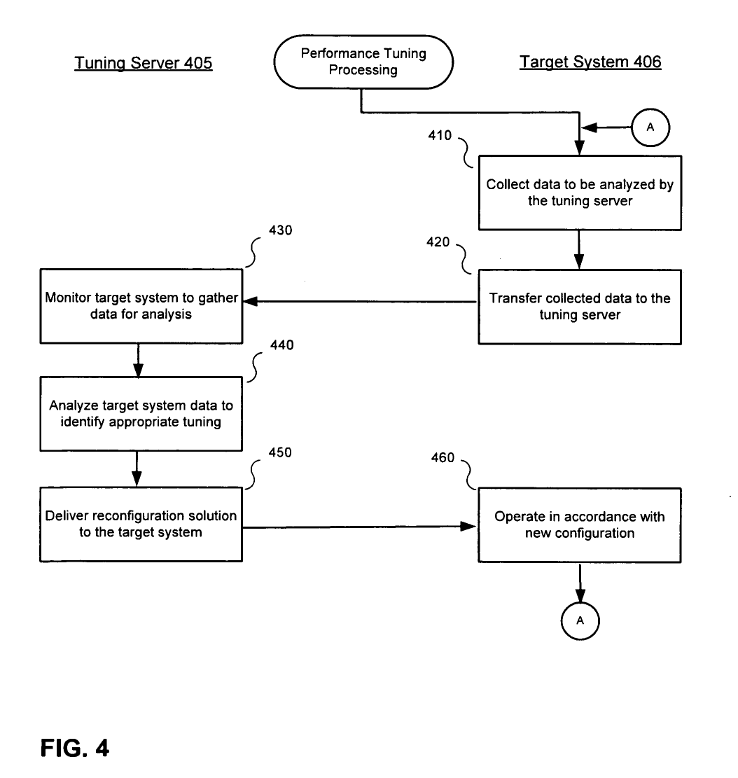

FIG. 4 is a high-level flow diagram illustrating performance tuning processing in accordance with an embodiment of the present invention. Depending upon the particular implementation, the various process and decision blocks described herein may be performed by hardware components, embodied in machine-executable instructions, which may be used to cause a general-purpose or special-purpose processor programmed with the instructions to perform the steps, or the steps may be performed by a combination of hardware, software, firmware and/or involvement of human participation/interaction. In the present example, processing taking place on a tuning server 405 are represented by processing blocks on the left hand side of the figure and processing taking place on a target system 406 are represented by processing blocks on the right hand side of the figure.

At block 410, the target system 406 collects data to be analyzed by the tuning server 405. As described above, depending upon the particular data to be analyzed, data collection may involve receiving, storing and potentially packaging of data regarding operation, performance, configuration and/or behavior of the target system 406. The collected target system data may also include information regarding observed events on the target system 406.

At block 420, the target system 406 transfers the collected data to the tuning server 405. Depending upon the particular implementation, the transfer of the collected target system data may involve one or more of the tuning server 405 polling or otherwise requesting the transfer of the collected target system data, the target system 406 pushing the collected target system data on a periodic basis or responsive to internal or external events, packaging of the collected target system data and transfer of the collected target system data via e-mail and transfer of the collected target system data via a dedicated protocol, such as SNMP or TCP.

At block 430, the tuning server 405 monitors the target system 406 to gather data for analysis. In some embodiments, the tuning server 405 periodically polls or logs into the target system 406 to initiate the transfer of collected target system data from the target system 406 to the tuning server 405.

At block 440, after receipt of the collected target system data, the tuning server 405 analyzes the data to identify appropriate tuning opportunities. For example, in embodiments in which the collected target system data includes profiling data, an analysis module associated with the tuning server 405 may identify frequently executed code paths to determine bottlenecks. The tuning server 405 may also identify potential code optimizations based on observed recurring input data processed by the target system 406. The tuning server 405 may additionally identify based on the collected target system data one or more configuration changes to configuration files, selected system parameters, operating system settings and/or settings for applications or other target system processes that are expected to improve the performance of the target system 406.

At block 450, the tuning server 405 delivers the proposed reconfiguration solution to the target system 406. In embodiments in which the target system 406 implement SNMP configuration interfaces, the tuning server 405 may send configuration updates or controlling requests through SNMP's SET protocol operation. In other embodiments, various other protocols, such as SSH, telnet, HTTP, SSL and the like, may be used to direct the reconfiguration of the target system 406.

Depending upon the circumstances, the reconfiguration solution may include one or more new application components, new images, one or more new configuration files, directives to remove one or more configuration files, code to mitigate observed attack/virus signatures, firmware for a peripheral device associated with the target system 406 and/or directives to change processor-specific options or other settings or configuration parameters associated with the target system 406. In some embodiments, the reconfiguration solution may also include directives to the target system 406 to alert the system administrator of certain conditions. For example, the tuning server 405 may alert the system administrator regarding a need to upgrade one or more hardware components.

At block 460, the target system 406 operates in accordance with the new configuration as directed by the reconfiguration solution delivered to the target system 406 by the tuning server 405. Depending upon the particular reconfiguration solution, this may involve restarting the target system 406, powering down one or more components of the target system 406 and/or the target system 406 presenting an alert or building and/or delivering a log to the end user or system administrator.

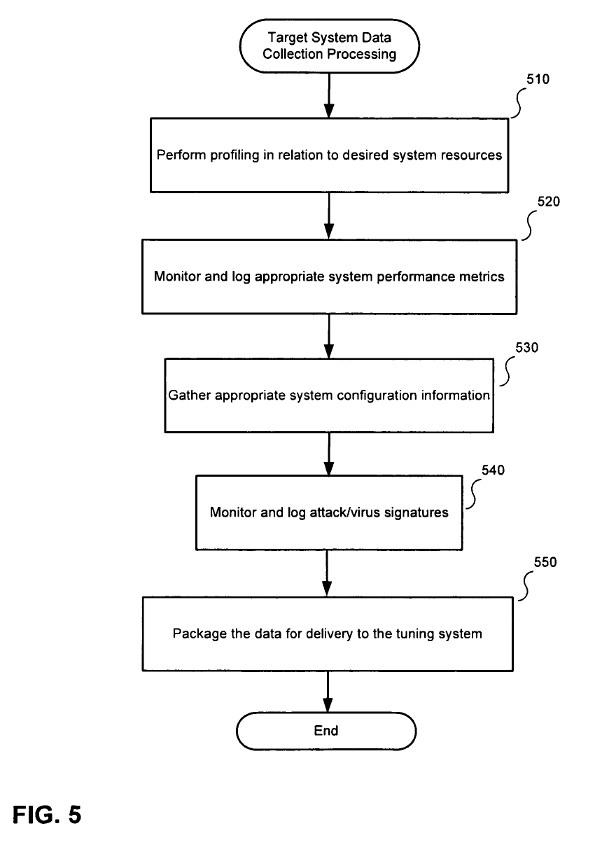

FIG. 5 is a flow diagram illustrating target system data collection processing in accordance with an embodiment of the present invention. According to the current example, at block 510, the target system performs profiling in relation to desired system resources. In some embodiments, various programs being executed by the target system contain code having profile points. When the profile points are encountered, corresponding counters are incremented to provide information regarding active/inactive code paths. In other embodiments, event-based or statistical profiling may employ hardware interrupts and/or operating system hooks to trap events of interest in relation to system resources of interest or probe the program counter of the target system at a configurable interval.

Regardless of the type of profiling employed, in embodiments in which profiling is performed, after a period of time, the target system will have collected a profile of how many times each of the code paths of interest has been executed during the profiling period. This data can typically be collected without adversely affecting system performance, and it can be stored with a relatively small memory footprint. The set of profile points may include system bottlenecks that will be called very frequently, and it may include error-handling cases that should be called rarely.

In one embodiment, the system has profile points for error cases that should never happen. If such profile points are triggered, the tuning server may be used to apply a hot patch, if one is available. In some cases, if these statements are reached, the target system may be configured to trigger generation of an intrusion detection system (IDS) log.

At block 520, the target system monitors and logs appropriate system performance metrics. In one embodiment, one or more of the following metrics may be tracked: mean or worst-case memory usage or central processing unit (CPU) usage, the target system's average or worst-case latency in processing a request, the amount of time spent in input/output (I/O) operations or swapping to disk, and the frequency with which certain faults occur. Other metrics can be used to measure system performance, including various external factors that may have an impact on system performance. For example, in a networking product, the average load at various times during the day, the distribution of protocols in the traffic being processed, frequency of security incidents such as viruses, attacks, etc. can also be monitored and logged.

At block 530, the target system gathers appropriate system configuration information. In one embodiment, configuration information in the form of selected system parameters, configuration files, status of processor-specific options, operating system settings and/or settings for applications or other target system processes are gathered. The configuration information gathered may itself be a configurable parameter set by the system administrator of the target system and/or by the tuning server.

At block 540, the target system monitors and logs attack/virus signatures. In one embodiment, when security incidents, such as viruses and/or attacks, are detected, information regarding the incidents is logged to allow such information to be provided to the tuning server for analysis.

At block 550, the collected target system data may be packaged for delivery to the tuning system. Depending upon the particular method of communicating the collected target system data from the target system to the tuning server, the packaging may include compression, encryption and the like.

Note that as implied by the exemplary nature of this diagram, there is no requirement that the above listed steps be performed in any particular order. Furthermore, any of the above steps could be omitted, and other steps could be added where relevant to the specific target system.

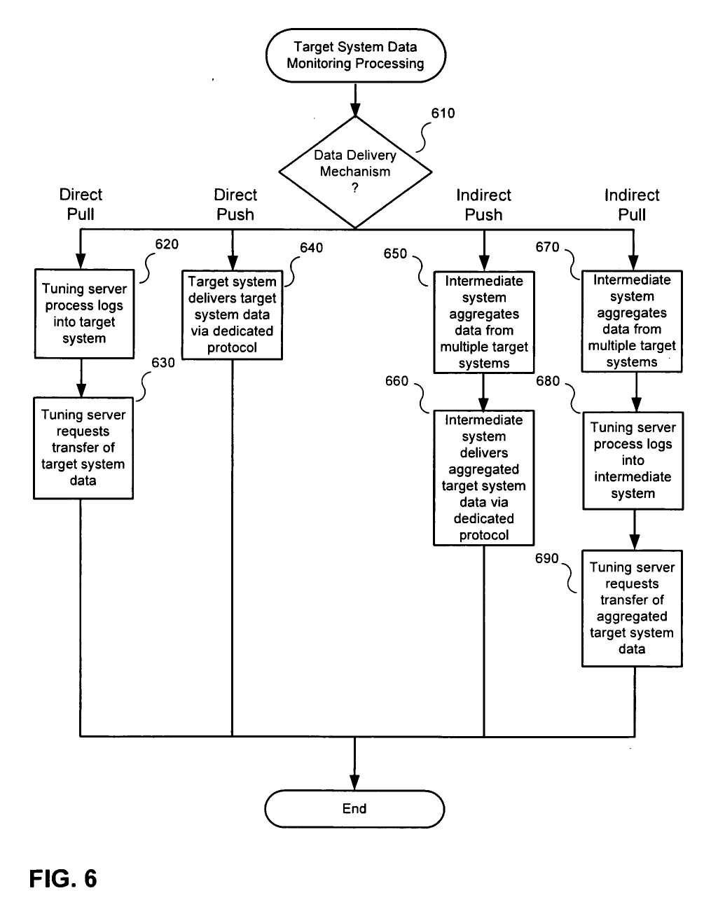

FIG. 6 is a flow diagram illustrating monitoring processing in accordance with an embodiment of the present invention. Depending upon the configuration of the tuning system, various monitoring techniques may be employed. For example, the target system data monitoring processing may be event-based and initiated based on one or more of a set of predetermined events occurring on the target system and/or the tuning server. Alternatively, the monitoring process may be periodically invoked based on a configurable timer.

At decision block 610, a determination is made regarding the current data delivery mechanism. If the tuning server pulls the collected target system data directly from the target system, the processing continues with block 620. If the target system pushes the collected target system data directly to the tuning server, then processing continues with block 640. If the tuning server pulls the collected target system data from an intermediate device, then processing continues with block 670.

In some embodiments, the tuning server may initiate the transfer of collected target system data directly from the target system. At block 620, if necessary, a process associated with the tuning server logs into an account on the target system. In one embodiment, the account may be part of a secure file transfer solution, such as a file transfer protocol (FTP) server. At block 630, the tuning server requests transfer of the collected target system data. In the context of SNMP, the tuning server can retrieve the collected target system data through the GET, GETNEXT and/or GETBULK protocol operations.

In other embodiments, the target system may initiate the transfer of collected target system data directly to the tuning server. At block 640, the target system delivers the collected target system data via a dedicated protocol. As described above, in some embodiments, SNMP can be extended to support the communication. In a typical SNMP implementation, an SNMP agent running on the target system would report the collected target system data via SNMP to the tuning server. In one embodiment, the SNMP agent sends the target system data to the tuning server without being asked using TRAP or INFORM protocol operations.

In some embodiments, an intermediate system may initiate the transfer of collected target system data from the intermediate system to the tuning server. At block 650, the intermediate system may aggregate collected target system data from multiple target systems. At block 660, the intermediate system delivers the aggregated collected target system data to the tuning server via a dedicated protocol.

In some instances, the intermediate system may provide the collected target system data responsive to a request from the tuning server. At block 670, the intermediate system may aggregate collected target system data from multiple target systems. At block 680, a tuning server process may log into an account on the intermediate system. At block 690, the tuning server requests transfer of the aggregated target system data.

Note that as implied by the exemplary nature of this diagram, there is no requirement that the above listed steps be performed in any particular order. Furthermore, any of the above steps could be omitted, and other steps could be added where relevant to the specific implementation.

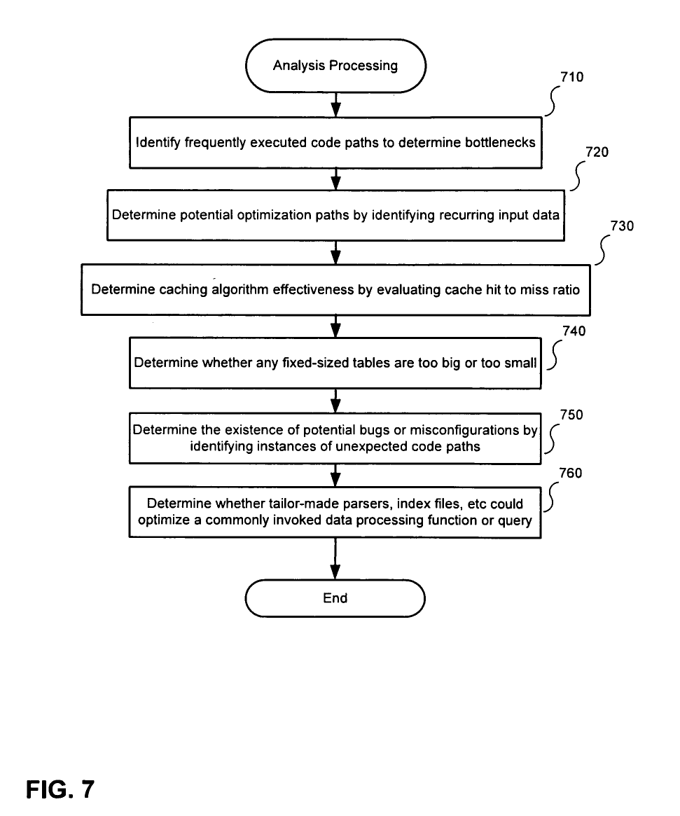

FIG. 7 is a flow diagram illustrating analysis processing in accordance with an embodiment of the present invention. The present example illustrates an exemplary set of analysis processing that may be performed on a target system program. The analysis processing may be invoked multiple times for a particular target system and a particular snapshot of collected target system data. For purposes of simplicity and brevity, only a single iteration of the analysis processing and a subset of the numerous possible analytical techniques are shown.

At block 710, bottlenecks are determined by identifying frequently executed code paths. In embodiments in which profiling data is part of the collected target system data, the profiling data may be evaluated by the tuning server. For example, a combination of execution times and corresponding performance counter values may be used to determine portions of code ripe for optimization or that may be removed altogether. In some embodiments, tuning/optimization processing may involve limited FPGA resources being allocated to whichever functionality is determined to be the actual bottleneck.

At block 720, based on recurring patterns of input data observed on the target system, the tuning server may identify potential optimization paths. For example, code changes may be identified for a particular program running on the target system to allow the program to more efficiently handle the recurring input data.

At block 730, caching algorithm effectiveness is determined by evaluating the cache hit to miss ratio. Cache replacement policy is typically suited to a particular class of applications or input data. In one embodiment, the caching algorithm may be tuned to outperform fixed choice algorithms by changing responsive to observed performance metrics. For example, the caching algorithm may initially be configured in accordance with a first policy for managing cache memory (e.g., a least recently used (LRU) discard policy); however, if the default algorithm is not meeting desired performance criteria, then it may be replaced with an another discard policy, e.g., a most recently used (MRU) caching algorithm, an adaptive replacement cache (ARC) algorithm It is also possible to replace the algorithm used to store a dataset (e.g. a binary tree vs. a hash table) depending on the performance of a data lookup or other metric under real conditions. Similarly, if and when the effectiveness of a tuned caching algorithm falls below desired performance criteria it may be replaced with yet another caching algorithm or one previously used. The write policy (e.g., write-through, write-back, no-write allocation, etc.) of the cache may also be adjusted based on the current or observed conditions on the target system.

In one embodiment, the caching algorithm's discard policy, the cache write policy and/or the amount of memory allocated to the cache may be selected or tuned based upon observations regarding one or more factors, including, but not limited to the cache hit to miss ratio, the type and character of the applications currently running on the target system, the most frequently executed programs on the target system, file request distributions, etc. Note that this same approach may be relevant to other internal implementation details that would not be classically called a “cache”. For example, a data file that is stored on the disk may be loaded into memory and parsed into an internal state by an application running on the target system. This is effectively a cache of the file; it consumes extra memory in order to allow quicker access to the parsed data, but the memory used by the cache can also be feed and reconstructed on demand later. Similarly, various user processes may temporarily store a copy of system variables that could be read from the kernel or from auxiliary devices on demand.

At block 740, a determination is made regarding whether any fixed-sized tables are too big or too small. For example, in one embodiment, pre-allocated memory pools may be evaluated for purposes of making a recommendation regarding appropriate size.

At block 750, the potential existence of bugs or misconfigurations are determined by identifying instances of unexpected code paths.

At block 760, it is determined whether efficient parsers and/or lexical analyzers index files, etc. could optimize a commonly invoked data processing function or query. In one embodiment, efficient parsers and lexical analyzers can be generated for known input parameters using tools such as Lex or YACC. In many cases, the relevant grammars or regular expressions are dependant on a specific enterprise's configuration or usage environment. In some embodiments, database accesses can be optimized using index files if it is determined that some queries are executed more frequently than others on the target system.

Note that as implied by the exemplary nature of this diagram, there is no requirement that the above listed steps be performed in any particular order. Furthermore, any of the above steps could be omitted, and other steps could be added where relevant to the specific implementation.

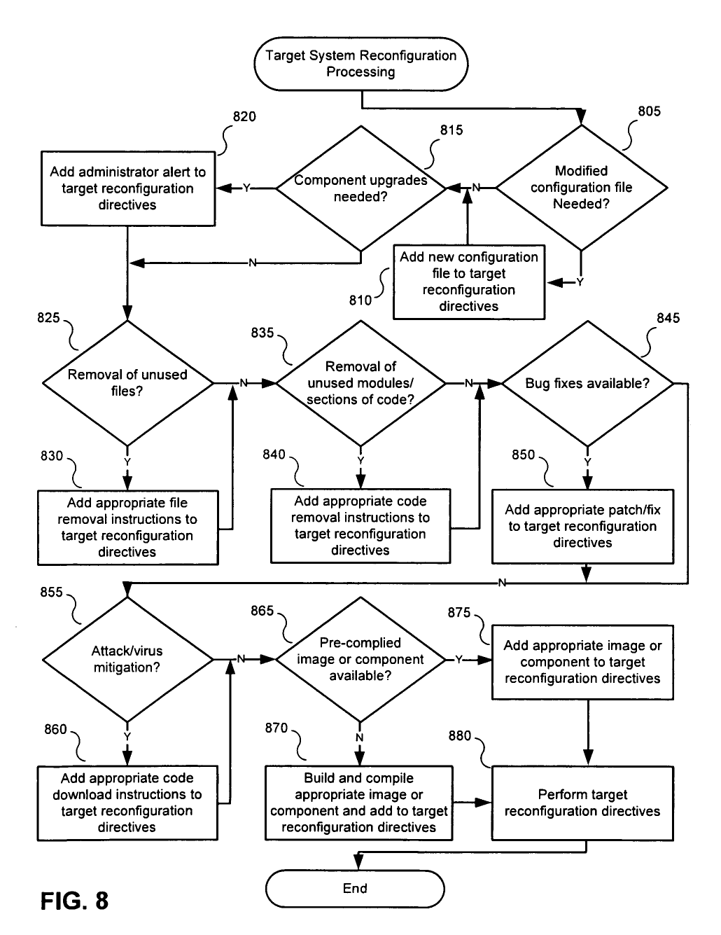

FIG. 8 is a flow diagram illustrating target system reconfiguration processing in accordance with an embodiment of the present invention. At decision block 805, a determination is made regarding the need for a modified configuration file, the need to modify operating system or processor-specific options and/or the need to reconfigure peripheral hardware on or associated with the target system. For example, the default configuration may relate to a specific daemon on the target system. However, the analysis server may determine that this daemon serves no useful purpose within the user's environment; and if so then the daemon could be disabled (e.g., an Internet Protocol Security (IPSec) daemon could be disabled if it is determined that none of the traffic policies require data encryption). Alternatively, the configuration file may include a variable, such as the size of a global hash table. As is well known in the art, the size of a hash table needs to be tuned to the size of the expected data set. If the size of the expected data set can be measured by the analysis server, then the configuration file can be amended to improve the performance of the system. If it is determined that the performance of the target system can be improved by such modifications/reconfigurations, then target system reconfiguration processing continues with block 810; otherwise processing branches to decision block 815.

At block 810, the appropriate modifications/reconfigurations are added to a list of target reconfiguration directives. For example, such directives may include instructions for copying one or more new configuration files to the target system, downloading a custom bit image for an FPGA on the target system, instructions for enabling/disabling operating system or processor-specific options, such as SMP or hyper-threading and/or instructions for altering caching functionality or operation.

At decision block 815, it is determined whether one or more target system component upgrades are needed. For example, based upon analysis of profiling data, the tuning server may choose to take some actions, such as upgrading individual components of the target system or even upgrading the whole system. In some cases, the target system is operating in a redundant “High Availability” cluster configuration (multiple hardware devices), in which case the member devices may be upgraded separately in order to avoid network downtime.

In some cases, the tuning server may conclude that the target system's hardware is not powerful enough to handle the anticipated load, and it may recommend that the user upgrade to a more powerful device (or add additional redundant devices). This notification could be communicated to the user via the target system's GUI or via e-mail or by messages in a log file. If one or more target system component upgrades are determined to be needed, then processing continues to block 820; otherwise processing branches to decision block 825.

At block 820, an administrator alert regarding the identified need for one or more component upgrades is added to the target reconfiguration directives.

At decision block 825, it is determined whether one or more files should be removed from the target system as a result of being unused. For example, based on observations indicative of the fact that only the English is being used in interactions with the target system, the analysis results may suggest that certain unused files relating to international language support be removed. Similarly, if the Remote Access Dialup User Service (RADIUS) protocol is not enabled in the target server's configuration, then the RADIUS daemon is just wasting space on the disk and it can be deleted. Subsequently, if the RADIUS service is enabled by an end user or system administrator, in a managed service implementation, the daemon may simply be downloaded from the central tuning server responsive to being enabled. At any rate, if files are identified that can be removed from the target system, then target system reconfiguration processing continues with block 830; otherwise, processing continues with decision block 835.

At block 830, the appropriate file removal instructions are added to the list of target reconfiguration directives.

At decision block 835, it is determined whether unused modules/sections of code can be removed or other code optimizations are to be implemented. For example, the profiling data may identify parts of one or more target system programs that are not in use. In some embodiments, it may be desirable to remove these unused parts or dead code. Additionally, based on recurring patterns of input data observed on the target system, for example, code changes may be identified for a particular program running on the target system to allow the program to more efficiently handle the recurring input data. If code changes are to be made, the processing continues with block 840; otherwise, processing branches to decision block 845.

At block 840, appropriate code removal instructions are added to the list of target reconfiguration directives. In one embodiment, the reconfiguration directives may direct the target system to replace the image for the program at issue on the target system with a new image (e.g., pre-build or newly compiled) based on one or more modified source code files. For example, the tuning server may directly or indirectly cause a binary application to be recompiled after enabling/disabling some conditional compilation options (e.g., #define vs. #undef statements in the C programming language). In other embodiments, the reconfiguration directives may direct the target system to create a new image based on one or more modified source code files.

At decision block 845, it is determined whether bug fixes, updates and/or security updates are available for the program at issue. In one embodiment, this is performed by conventional means, such as based on the version of the program at issue and the installation status of past updates and bug fixes. Notably, in some cases, the update may restore files that were removed by a previous optimization or proposed to be removed by a previous optimization step.

At block 850, appropriate patch(es)/fix(es) may be added to the list of target reconfiguration directives. In one embodiment, the reconfiguration directives may direct the target system to replace the image for the program at issue on the target system with a new image (e.g., pre-build or newly compiled) based on one or more modified source code files. In other embodiments, the reconfiguration directives may direct the target system to create a new image based on one or more modified source code files. In some cases, hot patches may be applied on the fly to the running copy of the image on the target system without having to restart the application being updated. In some cases, the tuning service may be integrated with other managed services, such as patch management services, in which agents installed on the target system listen for hot patches.

At decision block 855, it is determined whether code, patch(es) and/or fix(es) to mitigate observed attack/virus signatures are available for installation onto the target system. If so, processing continues with block 860; otherwise target system reconfiguration processing branches to decision block 865.

At block 860, the appropriate code, patch(es) and/or fix(es) to address observed attack/virus signatures are added to the list of target reconfiguration directives. In some embodiments, the target system contains a large number of attack/virus signatures (or code cases to detect rarely seen attacks), but not code to mitigate the attacks, however, if and when such attacks begin to occur, plugins, code, patches and/or fixes to mitigate these attacks can be downloaded from a central server via a just in time (JIT) tuning service.

As above, in some embodiments, the reconfiguration directives may direct the target system to replace an image with a pre-build or newly built image, the reconfiguration directives may direct the target system to create a new image itself based on modified source code and/or hot patches may be applied. In one embodiment, in addition to or instead of using patches and/or fixes, code updates delivered to the target system may include some randomly generated changes that do not necessarily provide any tuning advantage, but which provide resistance to known attack fingerprints via code polymorphism.

At decision block 865, it is determined if a pre-compiled image or component is available that meets the reconfiguration needs of the target system. If so, then processing continues with block 875; otherwise processing continues with block 870.

At block 870, an appropriate image or component is build and compiled and installation of the new image on the target system is added to the list of target reconfiguration directives. Then, processing continues with block 880.

At block 875, installation of the pre-compiled image or component on the target system is added to the list of target reconfiguration directives.

At block 880, the list of target reconfiguration directives are performed.

In various embodiment, more or less reconfiguration, optimization, tuning processing may be performed. For example, in some cases it may be desirable to switch from an algorithm of one complexity class to another based upon observations regarding quantities of data being processed. As one simple example, it is well known that P (polynomial time) algorithms (i.e., algorithms that can be solved in polynomial time based on the length of the input) will always be faster than NP (Nondeterministic Polynomial time); however, optimal results (e.g., taking into consideration both time and accuracy) may still be obtained from an algorithm of NP complexity for input sizes below a certain threshold. Consequently, according to various embodiments, based on observations regarding the size of data being processed by a particular algorithm, a potential tuning decision may be to switch to or from an algorithm of a greater or lesser complexity class. For example, an algorithm of P complexity may be used for large data sets and an algorithm of NP complexity may be used for data sets below a certain threshold.

Note that as implied by the exemplary nature of this diagram, there is no requirement that the above listed steps be performed in any particular order. Furthermore, any of the above steps could be omitted, and other steps could be added where relevant to the specific implementation.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A method comprising:
receiving data collected regarding a target system at a separate tuning server; and
if based on the data it is determined that performance attributes of the target system can be improved, then dynamically tuning the performance of the target system.

2. The method of claim 1, further comprising causing the target system to replace an application component of a program being executed by the target system with a new application component.

3. The method of claim 2, wherein the new application component is contained within an image chosen from a set of pre-built images.

4. The method of claim 2, wherein the new application component is built and compiled by the separate tuning server specifically for the target system based on the data.

5. The method of claim 1, wherein said dynamically tuning the performance of the target system includes making a change to a configuration file or script file on the target system.

6. The method of claim 1, further comprising applying a hot patch to an application image on the target system.

7. The method of claim 1, wherein the data comprises profiling data.

8. The method of claim 7, wherein the profiling data contains information indicative of active or inactive code paths of the existing program during a profiling period and wherein the method further comprises:
based on the profiling data, the separate tuning server (i) causing a first module or first section of code within the existing program to be restructured to provide more efficient code paths for more frequently encountered inputs or (ii) causing a second module or second section of code to be removed from the existing program.

9. The method of claim 1, wherein the data comprises metrics relating to one or more of memory utilization by the target system, central processor unit utilization by the target system, latency in processing a request by the target system, time spent in input/output operations by the target system, time spent swapping to a mass storage medium by the target system, occurrence of certain faults within the target system, load at various times of day on the target system, distribution of protocols in traffic being processed by the target system and frequency of security incidents observed by the target system.

10. The method of claim 9, further comprising the separate tuning server causing a value of a system parameter of the target system to be changed responsive to analysis of the metrics.

11. The method of claim 1, wherein the data contains information indicative of attacks attempted against the target system and wherein the method further comprises the separate tuning server causing code to mitigate the attacks to be uploaded to the target system.

12. The method of claim 1, wherein the new application component includes randomly generated changes that do not provide any tuning advantage, but which provide resistance to known attacks via code polymorphism.

13. The method of claim 1, wherein the new application component is recompiled after enabling or disabling one or more conditional compilation options within source code of the program.

14. The method of claim 13, wherein the new application component enables or disables symmetric multiprocessing, hyper-threading or configures other processor-specific options on the target system.

15. The method of claim 1, wherein said dynamically tuning the performance of the target system includes upgrading firmware of a peripheral associated with the target system.

16. The method of claim 1, wherein said dynamically tuning the performance of the target system includes supplying a new bit image to a field-programmable gate array (FPGA) associated with the target system.

17. The method of claim 1, wherein the data comprises configuration information indicative of whether certain services are enabled or disabled within the target system.

18. The method of claim 17, further comprising the separate tuning server causing files or code associated with one or more disabled services to be removed from the target system.

19. The method of claim 1, wherein the separate tuning server comprises customer-premises equipment (CPE) located geographically proximate to the target system.

20. The method of claim 1, wherein the separate turning server comprises service provider equipment (SPE) located geographically remote from the target system.

21. A computer system comprising:
a storage device having stored therein a software program configured to determine a need for performance tuning in relation to a separate target system; and
a processor coupled to the storage device and configured to execute the software program to analyze profiling data received from the separate target system, where
the profiling data provides information regarding active or inactive code paths of a program executed by the separate target system during a profiling period; and
based on the profiling data, if it is determined that one or more performance attributes of the separate target system can be improved, then the software program causing the performance of the separate target system to be dynamically tuned.

22. The computer system of claim 21, wherein the software program is further configured to cause the separate target system to replace an application component of a program being executed by the separate target system with a new application component.

23. The computer system of claim 21, wherein based on the profiling data, the software program (i) causes a first module or first section of code within an existing program running on the separate target system to be restructured to provide more efficient code paths for more frequently encountered inputs or (ii) causes a second module or second section of code to be removed from the existing program.

24. The computer system of claim 21, wherein the software program additionally receives from the separate target system metrics relating to one or more of memory utilization by the remove target system, central processor unit utilization by the separate target system, latency in processing a request by the separate target system, time spent in input/output operations by the separate target system, time spent swapping to a mass storage medium by the separate target system, occurrence of certain faults within the separate target system, load at various times of day on the separate target system, distribution of protocols in traffic being processed by the separate target system and frequency of security incidents observed by the separate target system.

25. The computer system of claim 24, wherein the software program causes a value of a system parameter of the separate target system to be changed responsive to analysis of the metrics.

26. The computer system of claim 21, wherein the software program additionally receives from the separate target system information indicative of attacks attempted against the separate target system and wherein the software program further causes code to mitigate the attacks to be uploaded to the separate target system.

27. The computer system of claim 21, wherein said causing the performance of the separate target system to be dynamically tuned includes upgrading firmware of a peripheral associated with the separate target system.

28. The computer system of claim 21, wherein said causing the performance of the separate target system to be dynamically tuned includes supplying a new bit image to a field-programmable gate array (FPGA) associated with the separate target system.

29. The computer system of claim 21, wherein the software program additionally receives from the separate target system configuration information indicative of whether certain services are enabled or disabled within the separate target system and wherein the software program is further configured to cause files or code associated with one or more disabled services to be removed from the separate target system.

30. The computer system of claim 21, wherein the computer system comprises customer-premises equipment (CPE) located geographically proximate to the separate target system.

31. The computer system of claim 21, wherein the computer system comprises service provider equipment (SPE) located geographically remote from the separate target system.
